(19) United States
(12) Patent Application Publication
(10) Pub. No.: US 2022/0259822 A1
(43) Pub. Date: Aug. 18, 2022

(54) Automated Mobilization of Mobile Machines

(71) Applicant: Caterpillar Inc., Peoria, IL (US)

(72) Inventors: Gautham Subramanian, Peoria, IL (US); Mark William Whiting, Peru, IL (US); Mark A. Tarvin, Canton, IL (US)

(73) Assignee: Caterpillar Inc., Peoria, IL (US)

(21) Appl. No.: 17/178,974

(22) Filed: Feb. 18, 2021

(51) Int. Cl. E02F 9/20; G05D 1/02

(52) U.S. Cl. CPC E02F 9/2045; E02F 9/2054; G05D 2201/0202; G05D 1/0238; E02F 9/205

(57) ABSTRACT

The disclosure describes technology that is related to mobile machines performing an automated mobilization task based on a mobilization command received from an electronic device that is separate from the mobile machines. The mobile machine may receive, from the electronic device, a mobilization command that instructs relocation of the mobile machine from an initial location to a final location. The mobile machine may traverse a path on a worksite that includes a series of locations extending from the initial location of the mobile machine to the final location. Furthermore, the mobile machine may determine its present position includes the final location, and, in response, send a relocation notification to the electronic device indicating that the mobilization task is completed.

### TECHNICAL FIELD

The present disclosure generally relates to the automated use of mobile machines at a worksite, and in particular, to the automated mobilization of mobile machines initiated by an electronic device separate from the mobile machine.

### BACKGROUND

A mobile machine may be, for example, a self-propelled vehicle having a work implement or tool operatively connected thereto to perform work, or a vehicle that is capable of hauling material or people. For example, such mobile machines may be construction machines such as bulldozers, wheel loaders, graders, compaction machines, off-highway trucks, and other earth-moving equipment or construction equipment typically found at a worksite. When a work project is in process, various mobile machines perform multiple tasks each day at different locations at the worksite. For example, an excavator may excavate a trench at one location on one day, and at another location three days later. In between, a haul truck may haul away the excavated material from the trenches.

To maximize their availability, the mobile machines are relocated to and from various locations at the worksite. In some instances, a mobile machine may be relocated to a work location at which the mobile machine will perform work, such as compaction. In other instances, a mobile machine may be relocated to a refueling area or a staging area where the mobile machine may be kept when construction and/or mining activity is not taking place. This relocation of mobile machines at a worksite is often referred to as “on-site mobilization” or, more simply, “mobilization.”

Conventionally, mobilization is accomplished manually. For example, a human operator is directed to find a particular mobile machine at a worksite and drive that machine to a specific location at the worksite. In so doing, the human operator often must use a vehicle to find a particular machine and another vehicle to return after driving the machine to its specific location. The labor costs and the management complexity associated with the human operators involved in mobilization can be substantial.

To avoid such expenses, some mobilization may be accomplished in an automated or semi-automated fashion. For example, U.S. Pat. No. 8,386,110 (hereinafter, “the '110 patent”) describes a travel route generating method for an unmanned vehicle. The travel route is generated within the constraints of the unmanned vehicle, such as turning radius or vehicle width, as well as to avoid any obstacles. Once the travel route is generated, the unmanned vehicle can travel that generated travel route.

While the system described in the '110 patent addresses a specific scenario involving unmanned vehicles, the system is not useful for the mobilization of relevant mobile machines on a worksite. For example, the system described in the '110 patent is reliant on input of vehicle constraints and information about obstacles. In some cases, this type of information may not be available or may be dynamically changing at a worksite, such as a construction site. Thus, the system described in the '110 patent lacks the flexibility to manage mobilization of one or more mobile machines in a practical and useful manner at a worksite.

Example systems and methods of the present disclosure are directed toward overcoming the deficiencies described above.

### SUMMARY

In an aspect of the present disclosure, a mobile machine includes a propulsion system, one or more sensors, and a controller that is operably connected to the propulsion system and the one or more sensors. The controller has one or more non-transitory computer-readable media storing computer-executable instructions that, when executed, cause one or more processors of the controller to perform operations. Those operations include receiving, from an electronic device separate from the mobile machine, a mobilization command to perform a mobilization task. The mobilization task includes moving the mobile machine from an initial location to a final location. The operations also include causing, using the propulsion system, the mobile machine to traverse a path on a worksite, the path including a series of locations, and extending from the initial location of the mobile machine to the final location. Furthermore, the operations include a determination, using the one or more sensors, that a present position of the mobile machine includes the mobilization location and, based on that, sending a mobilization task completion notification to the electronic device, the mobilization task completion notification indicating that the mobilization task is complete.

In another aspect of the present disclosure, one or more non-transitory computer-readable media stores computer-executable instructions that, when executed, cause one or more processors of a mobile machine to perform operations, such as receiving, from an electronic device separate from the mobile machine, a mobilization command to perform a mobilization task. The mobilization task including relocating the mobile machine from an initial location to a final location. The operations include determining a path on a worksite, the path including a series of locations, and extending from the initial location of the mobile machine to the final location and causing, using a propulsion system of the mobile machine, the mobile machine to traverse the path. Furthermore, the operations include a determination, using one or more sensors of the mobile machine, that a present position of the mobile machine is within a threshold distance of the final location and sending, based at least in part on determining that the present position is within a threshold distance of the final location, a mobilization task completion notification to the electronic device, the mobilization task completion notification indicating that the mobilization task is complete.

In yet another aspect of the present disclosure, a method includes receiving, by a mobile machine from an electronic device separate from the mobile machine, a mobilization command to perform a mobilization task. The mobilization task comprising relocating the mobile machine from an initial location to a final location. The method also includes determining, based at least in part from factors measured by one or more sensors of the mobile machine, that the mobile machine is in the safe operational condition, the factors being related to a safe operational condition of the mobile machine. Based at least in part to the to the determination that the mobile machine is in the safe operational condition, the method further includes causing, using a propulsion system of the mobile machine, the mobile machine to relocate from the initial location to the final location and determining, using a positioning system of the mobile machine, that a present position of the mobile machine includes the mobilization location and sending, based at least in part on determining that the present position includes the mobilization location, a mobilization task completion notification to the electronic device that the mobilization task is complete.

### BRIEF DESCRIPTION OF DRAWINGS

FIG. 1 illustrates an example system including an example worksite with mobile machines that are configured for automated mobilization, according to examples of the disclosure.

FIG. 2 illustrates a flowchart that depicts an example method for the mobile machine of FIG. 1 to perform a mobilization task, according to examples of the disclosure.

FIG. 3 illustrates a flowchart that depicts an example method to instruct the mobile machine of FIG. 1 to perform a mobilization task, according to examples of the disclosure.

FIG. 4 illustrates a flowchart that depicts an example method where the mobile machine of FIG. 1 autonomously performs an automated mobilization task after identifying that the mobile machine is in a condition to perform the mobilization task, according to examples of the disclosure.

FIG. 5 is a block diagram of an example controller that implements automated mobilization tasks of the mobile machines depicted in FIG. 1, according to examples of the disclosure.

FIG. 6 is a block diagram of an example electronic device for managing mobilization of mobile machines at a worksite, according to examples of the disclosure.

The following detailed description of the drawings provides references to the accompanying figures. In the figures, the left-most digit(s) of a reference number identifies the figure in which the reference number first appears. The use of the same reference numbers in different figures indicates similar or identical items. The systems depicted in the accompanying figures are not to scale, and components within the figures may be depicted not to scale with each other.

### DETAILED DESCRIPTION

This disclosure describes technology related to a mobile machine performing automated mobilization based on a command received from an electronic device that is separate from the mobile machine. A mobile machine may be, for example, an autonomous or semi-autonomous self-propelled vehicle that is configured to perform one or more operations associated with a given industry such as paving, excavation, mining, construction, farming, transportation, oil and gas, manufacturing, or any other suitable industry.

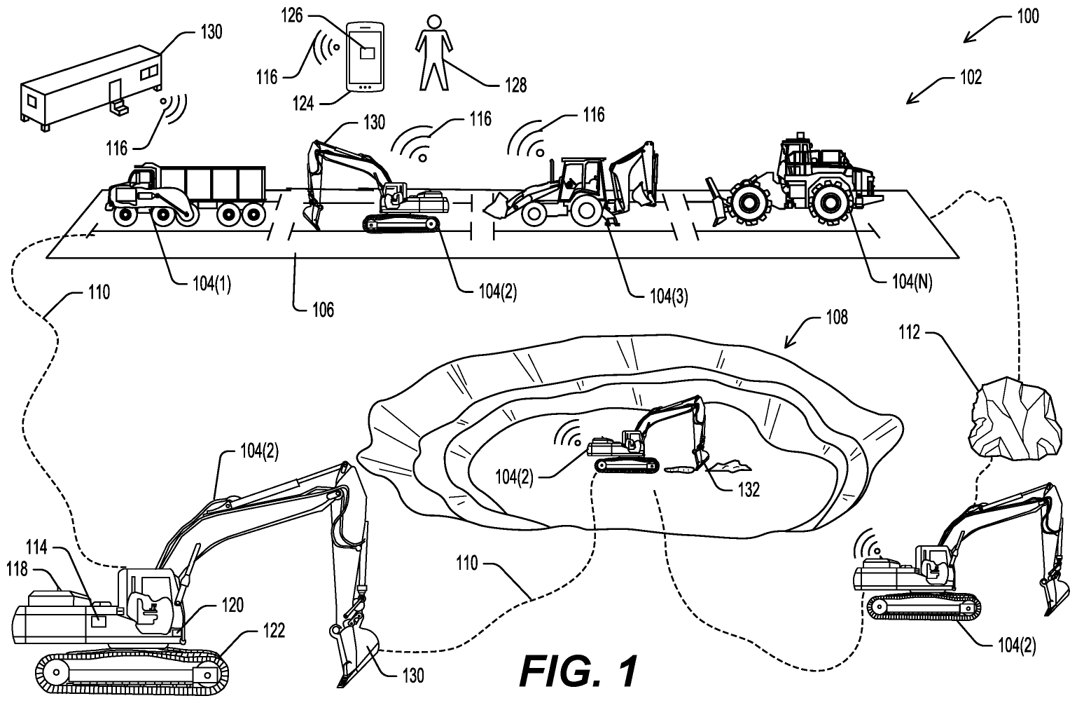

FIG. 1 illustrates an example system 100 disposed at an example worksite 102. The system 100 includes one or more mobile machines 104(1), 104(2), 104(3), . . . 104(N) (hereinafter referred to individually or collectively as “mobile machine 104” or “mobile machines 104”) that are configured for automated mobilization, according to examples of the disclosure. The mobile machines 104, although depicted here as a haul truck 104(1), excavator 104(2), backhoe 104(3), and a dozer 104(N), may be any suitable type of machine or tool that may be used in any variety of industries, such as construction, mining, farming, transportation, security services, oil and gas, etc. For example, the mobile machine 104 may be any suitable machine, such as any type of loader, dozer, dump truck, skid loader, excavator, compaction machine, backhoe, combine, crane, drilling equipment, tank, trencher, tractor, grading machine, articulated truck, asphalt paver, backhoe loader, cold planer, dragline, drill, electric rope shovel, forest machine, hydraulic mining shovel, material handler, motor grader, off-highway truck, pipelayer, road reclaimer, track loader, underground machine, utility vehicle, wheel loader, tanker (e.g., for carrying water or fuel), combinations thereof, or the like. The mobile machines 104, as disclosed herein, are configured for automated propulsion from one location at the worksite 102 to another location at the worksite 102. The mobile machines 104 may be configured to receive an indication of a desired movement or mobilization, and then automatically move according to the desired movement. The mobile machines 104 may still further be configured to determine a path that it traverses to automatically travel to various locations at the worksite 102. Furthermore, the mobile machines 104 are configured to, individually or in cooperation with each other, perform a commercial or industrial task, such as mining, construction, energy exploration and/or generation, manufacturing, transportation, agriculture, or any task associated with other types of industries. Although four mobile machines 104 are depicted here, it should be understood that there may be any suitable number of mobile machines 104 at a worksite 102, according to examples of the disclosure.

The worksite 102 includes a variety of different locations in which or to which the mobile machines 104 may be maneuvered, staged, maintained, stored, parked, supplied, and/or used to perform work, such as in an automated fashion. The worksite 102 may include, for example, a storage area 106, where the mobile machines 104 may be parked when not in use. For example, the mobile machines 104 may be stored at the storage area 106 overnight, when construction or mining activity is not being conducted. As a non-limiting example, in the realm of farming, a mobile machine 104 in the form of a tractor may be stored in the storage area 106 in a form of a large barn or garage. The worksite 102 may further include a work area 108 at which the mobile machines 104 engage in work activities, such as digging dirt, distributing asphalt, redistributing gravel, harvesting wheat, or the like. Although the work area 108 is depicted as an open pit mine, it should be understood that the work area 108 may be any suitable location in any suitable application, such as construction, mining, farming, transportation, or the like. For example, the work area 108 may be in the form of a paving site, an industrial site, a factory floor, a building construction site, a road construction site, a quarry, a building, a city, combinations thereof, or the like.

The worksite 102 further includes pathways 110 that the mobile machines 104 traverse to travel to various points of the worksite 102. For example, as depicted, the excavator 104(2) may traverse the pathway 110 to travel from the storage area 106 to the work area 108 and back to the storage area 106 in an automated way, according to examples of the disclosure. Although one particular pathway 110 of the excavator 104(2) is shown for illustrative purposes, it should be understood that there may be any variety of pathways 110 that may be traversed by the excavator 104(2) or any other mobile machine 104 at the worksite 102.

The worksite 102 may further include any variety of hazards 112 to be avoided by the mobile machines 104 while autonomously traversing the worksite 102. Although the hazard 112 is depicted as a boulder in the pathway 110 of the excavator 104(2), it should be understood that hazards 112 may be any suitable hazard that may prevent, impede, and/or render unsafe the movement therein or therethrough of the mobile machines 104. Non-limiting examples of the hazards 112 may include a boulder, a stone, mud, soft dirt, sand, a pit, a trench, a canyon, a pond, a river, a constructed structure, combinations thereof, or the like. In aspects of the disclosure, the mobile machines 104 are configured to autonomously relocate, as a mobilization task, via pathway 110, while avoiding hazards 112. Although some locations within the worksite 102 are depicted and discussed, it should be understood that there may be any number of different locations at the worksite 102, such as a refueling station, a recharging station, a resupply station, a parking area, a holding area, a maintenance garage, or the like. It should further be understood that the geographical and/or structural features of the worksite 102 may change over time, such as if a structure is built at the worksite 102 and/or if a mine is dug at the worksite 102. Thus, the pathway 110 that a mobile machine 104 may traverse in an automated fashion, as disclosed herein, may change with changes to the worksite 102.

The mobile machines 104 may include a controller 114 thereon that controls the autonomous movement of the mobile machine 104. The mobile machine 104 may receive wireless signal(s) 116 via an antenna 118 that is communicatively connected to the controller 114. The wireless signal 116, as received by the mobile machine may carry instructions and/or one or more commands for the mobile machine 104 to autonomously move within the worksite 102. For example, the wireless signal 116 may include an indication of a particular location at the worksite 102 to which the mobile machine 104 is to relocate. The controller 114 and/or other associated electronic hardware of the mobile machine 104 may process the wireless signal 116 to determine the location within the worksite 102 to which the mobile machine 104 is to be relocated in an automated way. The controller 114 may use any variety of sensors 120 of the mobile machine 104 to control a propulsion system 122 of the mobile machine 104 to relocate the mobile machine 104 to a desired location at the worksite 102, such as the location indicated by way of the wireless signal 116. Although the controller 114, the antenna 118, the sensors 120, and the propulsion system 122 are depicted on the excavator 104(2), it should be understood that each of the mobile machines 104 may have their own controllers 114, antennas 118, sensors 120, and propulsion systems 122.

The sensors 120 may include any suitable number and/or type of sensors 120 that generate sensor signals that are received and then processed by the controller 114 or other electronic hardware of the mobile machine 104 to indicate features (e.g., ground conditions, built structures, location, etc.) surrounding the mobile machine 104 and/or the current location of the mobile machine 104. The sensors 120 may include, for example, any one or more of Light Detection and Ranging (LIDAR) sensors, Radio Detection and Ranging (RADAR) sensors, Sound Detection and Ranging (SONAR) sensors, Global Navigation Satellite Sensors (GNSS) location sensors (e.g., Global Positioning Satellite (GPS) sensor, etc.), magnetic sensors (e.g., compass, etc.), inertial sensors (e.g., accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), combinations thereof, or the like. The sensors 120 may include multiple instances of each of these or other types of sensors 120. The sensors 120 are configured to provide sensor signals indicative of the surrounding conditions and/or surrounding features of the mobile machines 104. The controller 114 is configured to receive the sensor signals from the sensors 120 and process those sensor signals to identify the surrounding conditions, current location, and/or features proximal to the mobile machine 104. Different mobile machines 104 may have the same sensors 120 or different sensors 120.

The propulsion system 122, although depicted as a chain drive or continuous track of the excavator 104(2) may be any suitable drive system of the mobile machines 104. The propulsions system 122, as discussed herein may include an engine (not shown), electric motor (not shown), a steering system (not shown), and/or a transmission (not shown) of the mobile machine 104. The controller 114 is configured to control various aspects of the propulsions system 122 of the mobile machine 104, such as velocity or speed, direction, gears, etc. In general, the controller 114 may be configured to control the movement of the mobile machine 104 by controlling various components (e.g., engine, transmission, steering, etc.) of the propulsion system 122 of the mobile machine 104, such as in a similar manner as a human operator of the mobile machine 104 may control the propulsions system 122. For example, the controller 114 may operate various components of the propulsion system 122 in a fly-by-wire mechanism.

By using sensor signals from the sensors 120 and based at least in part on a desired final location of the mobile machine 104, the controller 114 is configured to cause the mobile machine 104 to move along the pathway 110 to reach the desired final location, such as the work area 108 or the storage area 106. The controller 114 uses the sensors 120 to identify its present position, such as by using GPS data, and/or to identify hazards 112 in its proximity, such as by using camera/imager data and/or LIDAR data. For example, senor signals from a sensor 120 in the form of a LIDAR may indicate that the mobile machine 104 that is being autonomously moved may be proximate to a hazard in the form of another mobile machine 104. In this case, the controller 114 may control the mobile machine 104 by controlling its propulsions system 122 such that its pathway 110 avoids a collision with the other mobile machine 104 as the mobile machine 104 is moved to its target location.

The system 100 may include an electronic device 124 configured to generate the wireless signal 116 that enables the transmission of a mobilization command to the controller 114 of the mobile machine 104 via the antenna 118. The electronic device 124 may have a software application running thereon to command the movement of the mobile machine 104. For example, the electronic device 124, with the software application running thereon, may generate the mobilization command and transmit the same via the wireless signal 116. The electronic device 124 may be controlled by an operator 128 (e.g., worksite 102 manager, construction worker, miner, farmer, paver, etc.) in some cases. Thus, the electronic device 124, with the software application running thereon, may receive input from the operator 128, such as via one or more human machine interface(s) (HMIs), to proceed with generating the mobilization command. The human operator 128 may provide any variety of parameters, corresponding to desired operating characteristics of the mobile machine 104 for the mobilization of the mobile machine 104, such as destination location, speed, etc. These parameters may be encoded by the electronic device 124 into a mobilization command that is transmitted to the one or more mobile machines 104 via the wireless signal 116. In some cases, the electronic device 124 may be housed in a trailer or control center 130 at the worksite 102.

The electronic devices 124, with the software application operating thereon, is further configured to communicate with the controller 114 of the mobile machine 104 to receive a confirmation message, or mobilization task completion notification, when the mobile machine 104 that was commanded to travel to a certain location has reached its destination. Thus, the mobile machine 104, after automatically traveling to a desired location at the worksite 102 sends a notification indicating completion of the assigned mobilization task, such as via the wireless signals 116, to the electronic device 124 that commanded the mobilization task of the mobile machine 104. The electronic device 124, upon receiving the indication of completion of the mobilization task, may be further configured to display to the operator 128 the completion of the requested mobilization task.

The electronic device 124, as depicted herein, is separate from the mobile machines 104. In other words, in aspects of the disclosure, the electronic device 124 is not physically wired to the mobile machines 104 or physically incorporated into or attached to the electrical wiring of the mobile machines 104. Rather, the electronic device 124 communicates with the mobile machine 104 wirelessly. In some instances, the communications between the electronic device 124 and the mobile machines 104 may be via protocol based communications (e.g., direct Wi-Fi, Wi-Fi, the Internet, Bluetooth, etc.), and in other instances, the communications may be non-protocol-based communications (e.g., remote control). In examples of the disclosure, the system 100 with communications between one or more electronic devices 124 and one or more mobile machines 104 may result in a worksite level network, such as a local area network (LAN) or a wide-area network (WAN). In alternative examples, the electronic device 124 may be incorporated in and/or otherwise hardwired to the mobile machine 104. The electronic device 124 may include a mobilization engine 126 configured to operate on the electronic device 124 to perform the functionality described herein. The mobilization engine 126 may be a hardware component, a software component, or a combination of hardware and software.

Although the electronic device 124 is depicted herein as a smartphone, it should be understood that the electronic device 124 may be any suitable electronic device. For example, the electronic device may be a computer, a mobile device, a server, a tablet computer, a notebook computer, a handheld computer, a workstation, a desktop computer, a laptop, any variety of user equipment (UE), a network appliance, an e-reader, a wearable computer, a network node, a microcontroller, a smartphone, or another computing device. The software application that operates on the electronic device 124 to enable it to control the operations of the mobile machines 104, such as autonomous mobilization, may be downloaded to the electronic device from any suitable website, such as a commercial app downloading website, or the like.

The electronic device 124 may, in some cases, be configured to control a single mobile machine 104, such as the mobilization task(s) of the mobile machine 104. In other cases, the electronic device 124 may be configured to control a number of mobile machines 104, such as all or some subset of all the mobile machines 104 at the worksite 102. The electronic device 124, in some examples, may generate a mobilization command for a single mobile machine 104 responsive to an interaction with the operator 128 or another electronic device 124. In other cases, the electronic device 124 may generate a mobilization command for two or more mobile machines 104 responsive to an interaction with the operator 128 or another electronic device 124. In either case, the mobilization command may instruct the target mobile machine(s) 104 to perform mobilization task(s) that relocates the mobile machine(s) 104 from their current location(s) at the worksite 102 to new location(s) at the worksite 102.

In some cases, a mobilization command generated by the electronic device 124 may provide a final or destination location to which the recipient mobile machine 104 is to move itself. This destination location may be specified in any suitable manner, such as latitude and longitude coordinates, worksite 102 specific coordinate system, feature identification (e.g., mobilization task to relocate to the work area 108). In the case where a mobilization task and/or location is referenced by a feature at the worksite (e.g., storage area 106), the electronic device 124 and/or the controller 114 may have access to a look-up table or other suitable mechanism that map feature locations to a suitable coordinate system, such as latitude and longitude coordinates.

In some examples, the electronic device 124, and the mobilization engine 126 thereon, may generate a mobilization command for a particular mobile machine 104 to indicate the desired final destination for that particular mobile machine 104, by way of the mechanisms discussed herein. An example of this case is the electronic device 124 receiving input from the operator 128 to relocate the excavator 104(2) from the storage area 106 to the work area 108. The electronic device 124, responsive to the input from the operator 128, may generate a mobilization command for the excavator 104(2) to relocate from the storage area 106 to the work area 108. As discussed herein, the work area 108 may be indicated in the mobilization command as a set of coordinates (e.g., latitude and longitude) or as a feature (e.g., work area 108). In the case that the final location is defined as a feature, the controller 114 will have a mapping (e.g., look-up table) that enables the translation of the feature (e.g., work area 108) to a set of coordinates (e.g., latitude and longitude). Although the mobilization command is discussed herein as a single command, such as in the form of a single data packet, it should be understood that the mobilization command sent to a particular mobile machine 104 from the electronic device 124 may be a series of commands and/or multiple data packets.

When the electronic device 124 sends this mobilization command to the mobile machine 104, via wireless signal 116 and antenna 118, the controller 114 may receive the mobilization command and determine the pathway 110 the as a series of waypoints along the pathway 110, such as defining the route from the storage area 106 to the work area 108. The controller 114 is configured to control the propulsion system 122 to move the mobile machine 104 according to the mobile command along the pathway 110 to the final destination of the work area 108. As the excavator 104(2) moves along the pathway 110, the controller 114 may be configured to receive sensor signals from the sensors 120. The controller 114 may further be configured to process the received sensor signals to identify if there are any hazards 112 along its pathway 110 that may interfere with the mobilization task, as assigned. The controller 114 may be configured to modify its pathway 110 to avoid any hazards 112 or possible hazards 112. Alternatively, the controller 114, upon detecting the hazard 112 in its pathway 110, may be configured to halt the movement of the mobile machine 104 and send a notification to the electronic device that there is a hazard 112 in its pathway, or that it is otherwise blocked from proceeding to its assigned final location.

In other examples, the electronic device 124 may generate the mobilization command to include the final destination, as well as one or more waypoints en route to the final destination. In this case, the electronic device 124 may define some or all of the pathway 110 that is to be traversed by the mobile machine 104 that is to execute the mobilization task. Thus, the electronic device 124 and the controller 114 of the mobile machine 104 may cooperate to define the pathway 110 to be traversed by the mobile machine 104 executing the mobilization task. The controller 114 may still use sensor signals from the sensors 120 to modify the pathway 110 traversed by the mobile machine 104 or cease the mobilization task, such as to avoid hazards 112.

In some cases, the electronic device 124 may be configured to generate a mobilization command in the form of a following task, where a mobile machine 104 is to perform a mobilization task in the form of following another mobile machine 104 or other vehicle. For example, a mobilization command of this type may instruct the excavator 104(2) to follow the haul truck 104(1) as the haul truck 104(1) traverses a path on the worksite 102. In this case, the haul truck 104(1) may be referred to as a pilot vehicle or pilot machine and the excavator 104(2) may be referred to as a follower machine. In some examples, the pilot machine may itself be performing an autonomous mobilization task. In this case, the electronic device 124 may generate and send a first mobilization command to the haul truck 104(1) to perform a mobilization task by proceeding to a destination location at the worksite 102 and the electronic device 124 may further send a second mobilization command to the excavator 104(2) to follow the haul truck 104(1) to the destination location. In other cases, the pilot vehicle may be driven by a human. Although a following mobilization task is discussed in the context two mobile machines 104 here, it will be appreciated that there may be any suitable number of follower machines that follow a pilot machine.

As another example, the electronic device 124 may be configured to generate multiple mobilization commands to instruct multiple mobilization tasks corresponding to multiple mobile machines 104. Thus, a single electronic device 124 may provide mobilization commands to control a plurality of mobile machines 104 contemporaneously. The mobilization command may be in the form of a data packet that includes header information indicating the mobile machine 104 (e.g., an identifier of the target mobile machine 104) for which the mobilization command is intended and the payload may indicate a destination location of the mobile machine 104 and/or and identification of another mobile machine 104 that the mobile machine is to follow. In some cases, the electronic device 124 may receive inputs from the operator 128 that indicates where each mobile machine 104 is to be located (e.g., a worksite plan), and may automatically generate different mobilization commands for each of mobile machines 104 based on the operator input. In this way, repetitive tasks for instructing the moving of multiple mobile machines 104 at a worksite 102 may be automated by the electronic device 124.

The electronic device 124 may still further be configured to receive from the mobile machine 104 an indication that the mobile machine 104 has completed its mobilization task. The electronic device 124, upon receiving an indication that the mobile machine 104 has completed its mobilization task, may display to the operator 128, such as on a graphical user interface (GUI) displayed on a display of the electronic device 124, that the mobile machine 104 has completed its mobilization task. For its part, the mobile machine 104, when assigned a mobilization task, may proceed to complete the mobilization task and then send a notification of completion, via its antenna 118 and wireless signal 116, to the electronic device 124 that sent the commands to perform the mobilization task. In examples of the disclosure, the controller 114 of the mobile machine 104 may monitor the location of the mobile machine 104 while performing its mobilization task, such as by using data received from the sensors 120 (e.g., GPS sensor data). When the controller 114 determines that the mobile machine 104 is sufficiently close (e.g., within a threshold distance) to the destination location, the controller 114 may deem that the mobilization task is complete. As a non-limiting example, the controller 114 may deem that a particular mobilization task is complete if the corresponding mobile machine is within 100 feet of the final destination location. In other examples, the threshold distance may alternatively be 10 meters, 50 feet, 75 feet, 25 meters, 100 meters, or any suitable threshold distance. When the controller 114 determines that the mobilization task is complete the controller 114 is configured to send the indication of completion of the mobilization task of the mobile machine 104.

The electronic device 124 may further be configured to command a work task, such as at the work area 108 of the worksite 102. For example, a work task may be an autonomous task where the mobile machine 104 may be able to perform the task at least partially without human control. The mobile machine 104 may include one or more work systems 132 that may be autonomously operated by the controller 114 of the mobile machine responsive to receiving the command for the work task from the electronic device 124. Although the work system 132 of the excavator 104(2) is depicted as a hydraulic system and bucket suitable for digging dirt or other loose materials, it should be understood that the work system 132 may be any work implement that may be used for any suitable type of work that the mobile machine 104 may perform. For example, a work task may involve automatically digging dirt at the work area 108, automatically redistributing asphalt, automatically piling gravel, automatically harvesting corn, automatically piledriving an iron beam, or automatically performing any kind of work that the mobile machine 104 is configured to perform. In some cases, the electronic device 124 may instruct both mobilization task(s) and work task(s) to one or more mobile machines 104. Thus, in some examples, the electronic device 124 may be configured to instruct the mobile machine(s) 104 to travel to a work area 108 and then perform a work task. Similar to when a mobile machine 104 completes a mobilization task, the controller 114 of a mobile machine 104 may be able to report back completion of a work task.

In some examples, the mobile machines 104 may operate according to various modes. These modes may allow interlocks and/or safety checks to prevent unwanted or unsafe actions. For example, in some cases, before a mobile machine 104 can engage in a mobilization task, the mobile machine 104 may have to be engaged in a mobilization mode. This mobilization mode may be instructed and/or switched from the electronic device 124 in a manner similar to how the electronic device 124 instructs a mobilization task. According to examples of the disclosure, switching the mobile machine 104 to a mobilization mode, at which point the mobile machine 104 can perform an instructed mobilization task, may first require an inspection of the mobile machine 104. The inspection may involve the operator 128 or other human technician inspecting the mobile machine 104 prior to placing the mobile machine 104 in the mobilization mode. The operator 128 may do a visual check of the mobile machine 104 or a more thorough check of fluids and components of the mobile machine 104 before using his or her electronic device 124 to place the mobile machine 104 in the mobilization mode. Alternatively, the inspection of the mobile machine 104 may be a self-diagnosis, where the controller 114 may identify if the mobile machine 104 is likely to operate under normal conditions, such as based on sensor signals from the sensors 120. Thus, regardless of whether an inspection is performed by a human or a self-diagnosis is performed by the controller 114, having to provide an interlock-type mode change (e.g., to the mobilization mode) provides an additional level of safety prior to engaging the mobile machine 104 in automated activities, such as a mobilization task. According to examples of the disclosure, there may be additional modes of operation of the mobile machines, such as an off-line mode where the mobile machine 104 may not be invoked by any mobilization commands or work commands, a work mode where the mobile machine may be ready to perform work activities, a manual mode where the mobile machine 104 may be operated by the operator 128 rather than autonomously, or the like.

It should be appreciated that the system 100, with interaction between the electronic device 124 and one or more mobile machines 104, allow for automated operations, such as an automated mobilization task, of the mobile machines 104 at the worksite 102. This can enable material, time, personnel, and/or cost savings in construction, mining, farming, or the like, as performed at the worksite 102. For example, moving a dozen mobile machines 104 at the worksite 102 from an initial location to a final location, such as from a fueling area to a work area, may traditionally require a dozen workers or more. According to the disclosure herein, among other benefits, significantly fewer human operators may be needed to safely complete the same task of moving mobile machines 104 at the worksite 102.

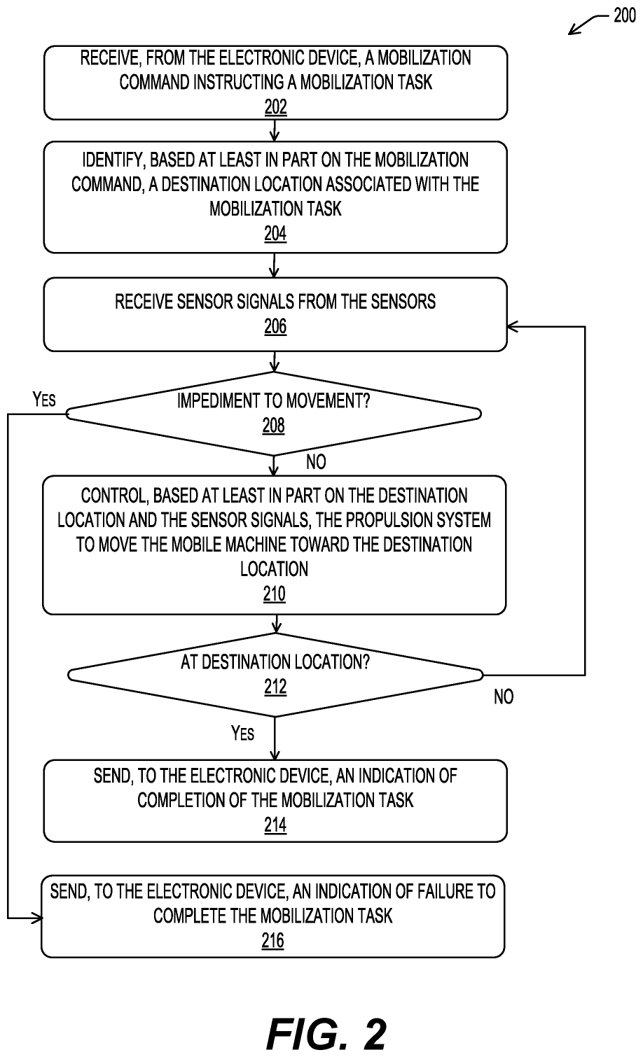

FIG. 2 illustrates a flowchart that depicts an example method 200 for the mobile machine 104 of FIG. 1 to perform a mobilization task, according to examples of the disclosure. The operations of method 200 may be performed by the controller 114 in cooperation with one or more entities of system 100.

At block 202, the controller 114 of the mobile machine 104 may receive, from the electronic device 124, a mobilization command instructing a mobilization task. The electronic device 124 may generate the mobilization command, such as based upon operator 128 input, and transmit the mobilization command via the wireless signal 116. Thus, the mobilization command may be encoded and/or modulated onto the wireless signal 116 that is received by the antenna 118 of the mobile machine 104. The controller 114 receives the wireless signal 116 and then decodes and/or demodulates the wireless signal 116 to identify the mobilization command. The mobilization command may include one or more parameters associated with the mobilization task that is to be completed by the mobile machine 104. The mobilization command may include one or more data packets with header portions that indicate at least the destination mobile machine 104 being instructed by those data packets. A payload portion of the data packets may include an indication of the various parameters associated with the mobilization task. The parameters may include at least an indication of the final or destination location of the mobile machine 104 upon completion of the mobilization task. Other parameterized information may include a speed of mobilization, a maximum speed of mobilization, a minimum speed of mobilization, one or more waypoints to the destination location, etc. In some cases, as discussed herein, the mobilization task may entail following another machine (e.g., a pilot vehicle).

At block 204, the controller 114 may identify, based at least in part on the mobilization command, a destination location associated with the mobilization task. The controller 114 may parse the mobilization command to identify various parameters encoded in the mobilization command, including the final destination to which the mobile machine 104 is to travel.

At block 206, the controller 114 may receive sensor signals from the sensors 120. As discussed herein, there may be any number of different sensors 120, such as a GPS receiver providing location signals, a camera providing image signals, a LIDAR, RADAR, and/or SONAR to provide ranging signals. These sensor signals may be processed by the controller 114 for identifying environmental factors and/or surrounding features of the mobile machine 104.

At block 208, the controller 114 may determine whether the mobile machine 104 impeded from movement. In other words, the controller 114 may determine whether the mobile machine 104 is unable to proceed toward the final destination, as indicated in the mobilization command. This may be determined using sensor signals from the one or more sensors 120. For example, the controller 114 may determine that there is a hazard 112 in its pathway 110 that the controller 114 is unable to maneuver the mobile machine 104 around and/or through. As another example, the controller 114 may not be receiving fresh and/or any sensor signals from the sensors 120 (e.g., the sensor(s) 120 may be malfunctioning and/or offline) and, as a result, the controller 114 not be able to navigate the mobile machine 104 toward the destination of its mobilization task. In yet another example, an impediment to proceed toward the final location may be prompted by the controller 114 being unable to establish and/or re-establish a communicative link with the electronic device 124. In still another example, the mobile machine 104 and/or the controller 114 may encounter a fault, an error, or otherwise not be able to execute the mobilization task.

If at block 208, the controller 114 determines that there is an impediment to movement of the mobile machine 104 (Block 208—Yes), then the method 200 may proceed to block 216, where the controller 114 may send, to the electronic device 124, an indication of failure to complete the mobilization task. In some cases, the indication of failure to complete the mobilization task may include an indication of why the mobilization task failed (e.g., communications fault, pathway 110 blockage, mobile machine 104 fault, etc.). If at block 208, the controller 114 determines that there is not impediment to movement (Block 208—No), then the method may proceed to block 210.

At block 210, the controller 114 may control, based at least in part on the destination location and the sensor signals, the propulsion system 122 to move the mobile machine 104 toward the destination location. In some instances, the controller 114 may perform the relocation of the mobile machine 104 by plotting a pathway 110 on the worksite that includes a series of locations extending from the initial location of the mobile machine 104 to the final location. In cases, where the mobilization command includes one or more waypoints along the pathway 110, the controller 114 may control the propulsions system 122 to move the mobile machine sequentially to each of the specified waypoints. If no waypoints are provided in the mobilization command, then the controller 114 may maneuver the mobile machine 104 in any suitable manner (e.g., shortest path, fastest path, etc.). As the mobile machine moves toward the final location the controller may course-correct based at least in part on the sensor data, as received from the sensors 120, to avoid hazards, as well as to identify the current position of the mobile machine 104. The controller 114 may control various aspects of the propulsion system 122, such as the engine (e.g., throttle valve), transmission (e.g., gear number), steering (e.g., direction), etc. to guide the mobile machine along the pathway 110 to the final location.

At block 212, the controller 114 may determine whether the mobile machine 104 is at the destination location. This may be determined using sensor signals from the one or more sensors 120. For example, the controller 114 may use GPS data to determine the current location of the mobile machine 104. The controller 114 may compare the current location of the mobile machine 104 to the final location and make a determination if the mobile machine 104 has arrived at the final location. In some cases, the controller 114 may determine that it has arrived at the final location, if the current location is within a threshold distance (e.g., 50 feet) of the final location. If the controller 114 determines that the mobile machine 104 is not at the destination location (Block 212—No), then method 200 may return to block 206, where additional sensor signals may be received and then used to continue towards the destination location. In this way, the controller 114 may repeatedly use fresh sensor data to control the propulsions system 122 and guide the mobile machine to the final location, as specified in the mobilization command received from the electronic device 124.

If the controller 114 determines that the mobile machine 104 is at the destination location (Block 212—Yes), then method 200 proceeds to block 214, where the controller 114 sends an indication of completion of the mobilization task to the electronic device 124. The mobilization task completion notification includes an encoded message or set of messages with information about the mobile machine 104, the assigned mobilization task, and/or the final location. The sending of the mobilization task completion notification may indicate, to the electronic device 124, that the mobilization task is complete and the mobile machine 104 is relocated to the final location. Thus, the current location of the mobile machine 104 includes the final location. When the electronic device 124 is notified of the completion of the mobilization task, the electronic device 124 may indicate the completion of the mobilization task to the operator 128. In some cases, the electronic device 124 may command another task, such as another mobilization task and/or work task.

It should be noted that some of the operations of method 200 may be performed out of the order presented, with additional elements, and/or without some elements. Some of the operations of method 200 may further take place substantially concurrently and, therefore, may conclude in an order different from the order of operations shown above. It should also be noted that in some cases, there may be other components of the system 100 involved in one or more of the operations, as described herein.

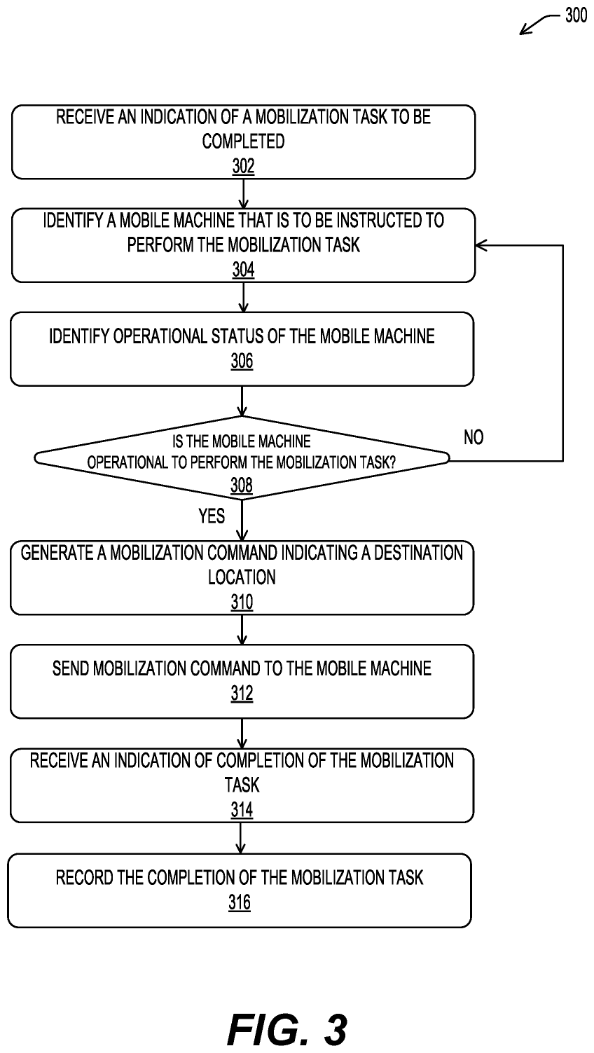

FIG. 3 illustrates a flowchart that depicts an example method 300 to instruct the mobile machine 104 of FIG. 1 to perform a mobilization task, according to examples of the disclosure. The operations of method 200 may be performed by the electronic device 124 in cooperation with one or more entities of system 100.

At block 302, the electronic device 124 may receive an indication of a mobilization task to be completed. This indication may be received via an HMI of the electronic device, such as from operator 128. The indication may identify a particular mobile machine 104 or a type of mobile machine 104 (e.g., a dozer, a haul truck, an excavator, etc.) that is to perform a mobilization task.

At block 304, the electronic device 124 may identify a mobile machine that is to be instructed to perform the mobilization task. The particular mobile machine 104, in some cases, may be specified at block 302, or alternatively, the electronic device 124 may select the particular mobile machine 104 from an inventory of mobile machines 104 at the worksite 102. For example, if the mobilization task is to be completed by a haul truck and there are four different haul trucks at the worksite 102, the electronic device 124 may pick one of the haul trucks according to any suitable factor, such as the haul truck that has been more recently fueled, the haul truck that has been used the least, etc.

At block 306, the electronic device 124 may identify the operational status of the mobile machine 104. In some cases, the mobile machine 104 may be offline and not ready to receive and/or execute mobilization commands. The electronic device 124 may track the modes and/or operational status of all, or some, of the mobile machines 104 at the worksite 102. Alternatively, the electronic device 124 may query the operational status of the mobile machine 104 by communicating with the controller 114 of the mobile machine 104.

At block 308, the electronic device 124 may determine whether the mobile machine 104 is operational to perform the mobilization task. This determination may be based at least in part on the operational status assessment of block 306. If the electronic device 124 determines that the mobile machine 104 is not operational to perform the mobilization task (Block 308—No), then the method 300 may return to block 304 where another mobile machine 104 may be identified for performing this or another mobilization task. If, however, the electronic device 124 determines that the mobile machine 104 is operational to perform the mobilization task, then the method 300 proceeds to block 310. At block 310, the electronic device 124 generates a mobilization command indicating a destination location and/or other parameters associated with performing the mobilization task. As discussed herein, the mobilization command may be in the form of one or more data packets that carry parameters of the mobilization task, such as the final location to which the mobile machine 104 is to relocate.

At block 312, the electronic device 124 sends the mobilization command to the mobile machine 104. As discussed herein, the mobilization command may be modulated and/or encoded onto the wireless signal 116 transmitted by the electronic device 124 and received by the antenna 118 of the mobile machine 104. This enables the mobile machine 104, under the control of the controller 114, to perform the mobilization task of relocating to the final location at the worksite 102 according to any other parameters that may be specified in the mobilization command. Upon completion of the mobilization task, the controller 114 of the mobile machine 104 may send an indication of completion of the mobile task back to the electronic device 124.

At block 314, the electronic device 124 may receive an indication of completion of the mobilization task. Receipt of this indication confirms to the electronic device 124 that the assigned mobilization task has been completed by the mobile machine 104. In other words, the mobile machine 104 is now at the final location (e.g., within a threshold distance of the final location). At block 316, the electronic device 124 may record the completion of the mobilization task. In some cases, the electronic device 124 may display, to the operator 128, that the mobilization task has been completed. In some cases, the electronic device may dispatch a work task and/or an additional mobilization task to the same mobile machine 104 or other mobile machine(s) 104.

It should be noted that some of the operations of method 300 may be performed out of the order presented, with additional elements, and/or without some elements. Some of the operations of method 300 may further take place substantially concurrently and, therefore, may conclude in an order different from the order of operations shown above. It should also be noted that in some cases, there may be other components of the system 100 involved in one or more of the operations, as described herein.

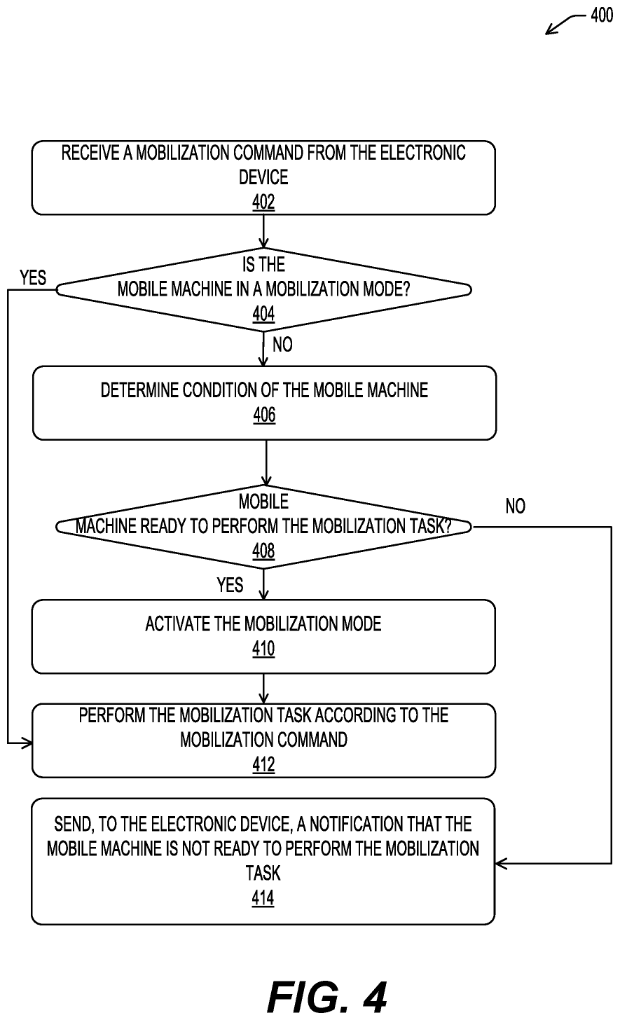

FIG. 4 illustrates a flowchart that depicts an example method 400 where the mobile machine 104 of FIG. 1 autonomously performs an automated mobilization task after identifying that the mobile machine 104 is in a condition to perform the mobilization task, according to examples of the disclosure. The operations of method 400 may be performed by the controller 114 in cooperation with one or more entities of system 100.

At block 402, the controller 114 may receive a mobilization command from the electronic device 124. The electronic device 124 may generate the mobilization command, such as based upon operator 128 input, and transmit the mobilization command via the wireless signal 116. Thus, the mobilization command may be encoded and/or modulated onto the wireless signal 116 that is received by the antenna 118 of the mobile machine 104. The controller 114 receives the wireless signal 116 and then decodes and/or demodulates the wireless signal 116 to identify the mobilization command. The mobilization command may include one or more parameters associated with the mobilization task that is to be completed by the mobile machine 104. The mobilization command may include one or more data packets with header portions that indicate at least the destination mobile machine 104 being instructed by those data packets. A payload portion of the data packets may include an indication of the various parameters associated with the mobilization task. The parameters may include at least an indication of the final or destination location of the mobile machine 104 upon completion of the mobilization task. Other parameterized information may include a speed of mobilization, a maximum speed of mobilization, a minimum speed of mobilization, one or more waypoints to the destination location, etc.

At block 404, the controller 114 may determine whether the mobile machine 104 is in a mobilization mode, or otherwise ready to perform mobilization task(s). The controller 114 may keep a register of what mode it is in. This allows the controller 114 to block any actions that may be requested that are not consistent with its current mode. For example, if the mobile machine 104 is not in the mobilization mode, it may not be ready to perform a requested mobilization task.

If the controller 114 determines that the mobile machine 104 is in the mobilization mode (Block 404—Yes), then the method 400 may proceed to block 412, where the controller 114 performs the mobilization task according to the mobilization command. This mobilization task may be performed according to the operations as described in method 200 of FIG. 2. If the controller 114 determines that the mobile machine 104 is not in the mobilization mode (Block 404—No), then the method 400 may proceed to block 406.

At block 406, the controller 114 determines the condition of the mobile machine 104. In examples, the controller 114 may perform a self-diagnosis of the mobile machine 104 to assess its condition. The sensors 120 may be used to perform this self-diagnosis. The one or more sensors 120 may be used to measure factors related to or indicative of a safe operational condition of the mobile machine and/or whether the mobile machine is operational at all. Measured factors related to or are indicative of an operational condition or safe operational condition may include level detection, engine measurements, fluid levels, gas pressure, engine temperature, fuel levels, charge levels, wheel or track slippage, and the like.

At block 408, the controller 114 may determine whether mobile machine 104 is ready to perform the mobilization task. This determination may be based on the conditions determined by the operations of block 406. If the controller 114 determines that the mobile machine 104 is ready to perform the mobilization task (Block 408—Yes), then the controller 114, at block 410, may activate the mobilization mode of the mobile machine 104. After that, the controller 114, at block 412, may perform the mobilization task according to the mobilization command. If the controller 114 determines that the mobile machine 104 is not ready to perform the mobilization task (Block 408—No), then the method 400 may proceed to block 414. At block 414, the controller 114 may send, to the electronic device 124, a notification that the mobile machine 104 is not ready to perform the mobilization task. This notification may make the electronic device 124 and, in turn, the operator 128 aware that the mobile machine cannot, at this time, perform the mobilization task.

As can be seen form FIGS. 4-6 the electronic device 124 can be used to mobilize one or more mobile machines 104 in an autonomous fashion. This provides for several benefits, including requiring less human labor to move the mobile machines 104 to the locations that those mobile machines 104 need to be at the worksite 102.

It should be noted that some of the operations of method 400 may be performed out of the order presented, with additional elements, and/or without some elements. Some of the operations of method 400 may further take place substantially concurrently and, therefore, may conclude in an order different from the order of operations shown above. It should also be noted that in some cases, there may be other components of the system 100 involved in one or more of the operations, as described herein.

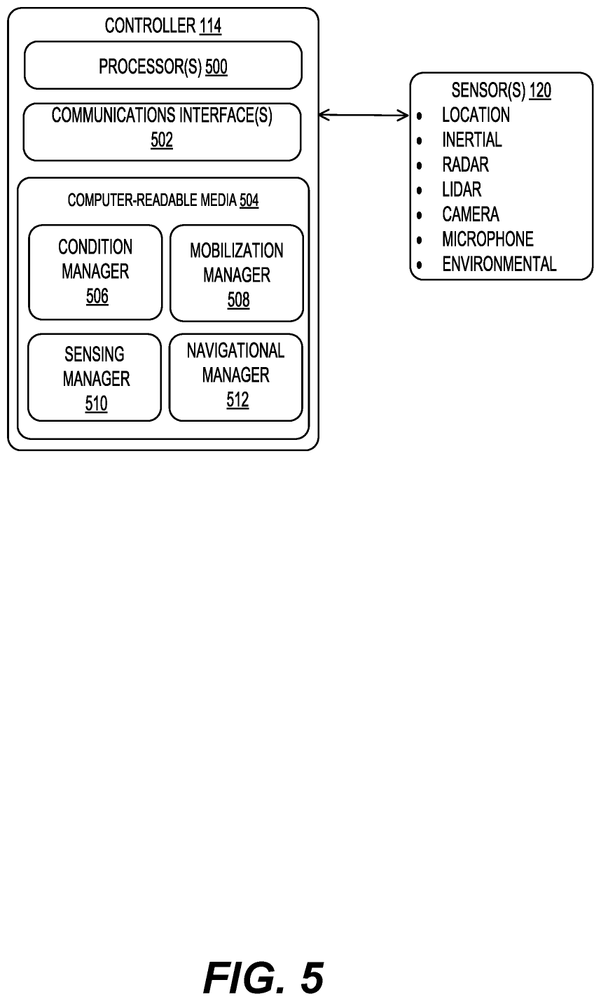

FIG. 5 is a block diagram of an example controller 114 that implements automated mobilization tasks of the mobile machines 104 depicted in FIG. 1, according to examples of the disclosure. In some cases, there may be more than one controller that performs the operations, as discussed herein. In those cases, the other controllers that may cooperate with controller 114 to enable the mobile machine 104 functions, as described herein, may be similar to the controller 114. The controller 114includes one or more processor(s) 500, one or more communication interface(s) 502, and computer-readable media 504.

In some implementations, the processors(s) 500 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 500 may possess its own local memory, which also may store program modules, program data, and/or one or more operating systems. The one or more processor(s) 500 may include one or more cores.

The communications interface(s) 502 may enable the controller 114 to communicate via the one or more network(s), such as via the wireless signals 116. The communications interface(s) 502 may include a combination of hardware, software, and/or firmware and may include software drivers for enabling any variety of protocol-based communications, and any variety of wireline and/or wireless ports/antennas. For example, the communications interface(s) 502 may comprise one or more of WiFi, cellular radio, a wireless (e.g., IEEE 802.1x-based) interface, a Bluetooth® interface, and the like. In some cases, if a remote control is used to control the mobile machine 104, the communications interface(s) 502 may enable the use of remote control signals to communicate with the mobile machine 104.

The computer-readable media 504 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 504 may be implemented as computer-readable storage media (CRSM), which may be any available physical media accessible by the processor(s) 500 to execute instructions stored on the computer-readable media 504. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 500. The computer-readable media 504 may have an operating system (OS) and/or a variety of suitable applications stored thereon. The OS, when executed by the processor(s) 500 may enable management of hardware and/or software resources of the controller 114.

Several components such as instruction, data stores, and the like may be stored within the computer-readable media 504 and configured to execute on the processor(s) 500. The computer readable media 504 may have stored thereon a condition manager 506, a mobilization manager 508, a sensing manager 510, and a navigation manager 512. It will be appreciated that each of the components 506, 508, 510, 512 may have instructions stored thereon that when executed by the processor(s) 500 may enable various functions pertaining to automated mobilization of the mobile machine 104, as described herein.

The instructions stored in the condition manager 506, when executed by the processor(s) 500, may configure the controller 114 to perform a self-diagnostic, using the various sensors 120 to determine if the mobile machine 104 is in a safe condition for autonomous mobile operation. The controller may receive sensor signals and process the same to enable any mode change, such as the mobilization mode that allows autonomous mobilization tasks.

The instructions stored in the mobilization manager 508, when executed by the processor(s) 500, may configure the controller 114 to execute a mobilization task according to a received mobilization command from the electronic device 124. The mobilization command may instruct relocating the mobile machine 104 to a final location at the worksite 102 from its current location. In some cases, the mobilization command may instruct following a pilot vehicle. Thus, the controller 114 is configured to receive the mobilization command and control the propulsion system 122 to perform the assigned mobilization task.

The instructions stored in the sensing manager 510, when executed by the processor(s) 500, may configure the controller 114 to receive sensor 120 based data, including GPS location data, and process the same. The controller 114 is configured to determine environmental factors from the sensor data, as well as the present location of the mobile machine 104. The Controller 114 is further configured to determine any features or hazards 112 near the mobile machine 104 and/or along the pathway 110 of the mobile machine 104 while performing a mobilization task.

The instructions stored in the navigation manager 512, when executed by the processor(s) 500, may configure the controller 114 to control the propulsion system 122 according to various data available. The controller 114 guides the mobile machine 104 along the pathway 110 towards the final location, as instructed in a received mobilization command instructing a mobilization command.

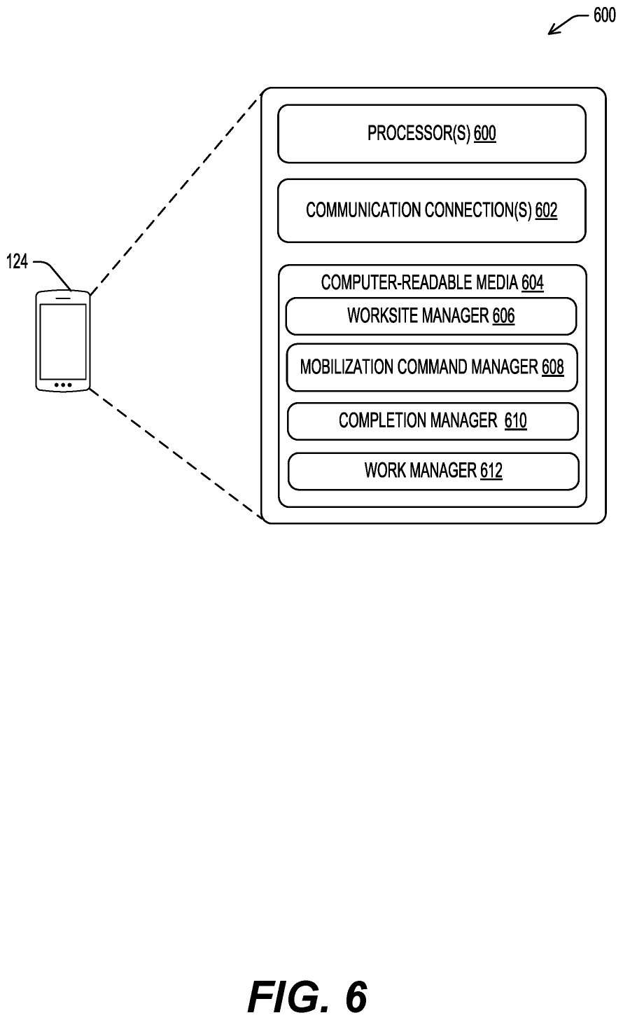

FIG. 6 is a block diagram of an example electronic device 124 for managing mobilization of mobile machines 104 at a worksite, according to examples of the disclosure. The hardware and software, as discussed herein, may be an implementation of the mobilization engine 126 of the electronic device 124. In some cases, there may be more than one electronic device 124 at a worksite 102, as discussed herein. In those cases, the other electronic device(s) 124 may be similar to the electronic device 124, as described herein. The electronic device 124 includes one or more processor(s) 600, one or more communication interface(s) 602, and computer-readable media 604. The descriptions of the one or more processor(s) 600, the one or more communication interface(s) 602, and the computer-readable media 604 may be substantially similar to the descriptions of the one or more processor(s) 600, the one or more communication interface(s) 602, and the computer-readable media 604, as described in conjunction with FIG. 5 herein, and in the interest of brevity, will not be repeated here.

Several components such as instruction, data stores, and the like may be stored within the computer-readable media 604 and configured to execute on the processor(s) 600. The computer readable media 604 may have stored thereon a worksite manager 606, a mobilization command manager 608, a completion manager 610, and a work manager 612. It will be appreciated that each of the components 606, 608, 610, 612 may have instructions stored thereon that when executed by the processor(s) 600 may enable various functions pertaining to automated mobilization of the mobile machine 104, as described herein.

The instructions stored in the worksite manager 606, when executed by the processor(s) 600, may configure the electronic device 124 to identify the mobile machines 104 at a worksite 102. The electronic device 124 may determine the types of machines the mobile machines 104 at the worksite 102 might be, along with identifiers of the individual mobile machines 104. The electronic device 124 may further be configured to identify the current positions of each of the mobile machines 104 at the worksite 102 and display the same to an operator 128, such as in the form of a map.

The instructions stored in the mobilization command manager 608, when executed by the processor(s) 600, may configure the electronic device 124 to generate a mobilization command that provides one or more parameters to instruct a mobilization task of moving from a current location of a mobile machine 104 to a final location of the mobile machine 104. In some cases, the electronic device 124, via the mobilization command may instruct a mobile machine to autonomously proceed to the final destination. In other cases, the electronic device 124 may instruct a mobile machine 104 to follow another machine and/or pilot vehicle.

The instructions stored in the completion manager 610, when executed by the processor(s) 600, may configure the electronic device 124 to receive, such as from a controller 114 of a mobile machine 104, that a mobilization task has been completed. The electronic device 124 may then be configured to provide an indication, such as to the operator 128, that the assigned mobilization task has been completed.

The instructions stored in the work manager 612, when executed by the processor(s) 600, may configure the electronic device 124 to instruct a work task to a mobile machine 104. In some cases, the electronic device 124 may assign a work task to a mobile machine 104 that completed a mobilization task. For example, if a mobilization task was for the mobile machine 104 to proceed to a work area 108, then upon completion of that mobilization task, the electronic device 124 may instruct the mobile machine to perform a work activity at the work area 108.

### INDUSTRIAL APPLICABILITY

With the technologies described herein, the mobilization of a mobile machine 104 on a worksite 102 (such as a construction site) may be automated. In other words, mobile machines 104 that perform construction, mining, farming, and other activities may be autonomously moved from one location to another at the worksite 102 with no or less human involvement than traditional methods. For example, a farmer who is at his or her crop fields may wish to have his or her tractor at the fields, rather than in the barn, where it is parked. The farmer, instead of having to walk or drive back to his or her barn to drive the tractor to the crop fields, can use his or her electronic device to call the tractor to come to his location at the crop field. This process saves the farmer precious time that he or she could use to engage in other farming activities.

In another non-limiting application of the technologies described herein, consider a large mining operation with various mineral extraction points and dozens of mobile machines 104 at the worksite 102. In such an operation, a number of people may be need just to move machinery from one location to another, such as from a mine pit to a refueling station, or from a work area to a storage area at the end of the work day. The technologies described herein can automate these types of mobilization tasks. This may allow the mobile machines 104 at a worksite 102 to be used more efficiently and with less human oversight. This can reduce the labor costs associated with the considerable amount of movement of machines at a large worksite 102. Additionally, in traditional mechanisms, a machine that needs to be moved may have to wait for a human operator who is available to come to the machine and move it. During this time, the machine may be sitting idle and may further be wasting fuel and hours between maintenance. Using the technologies disclosed herein, the idle time of these machines may be reduced and/or eliminated. Additionally, the machines may be serviced, refueled, maintained, etc. on a more precise schedule than human operators can enable. Thus, the technologies described herein, not only reduce human oversight and associated costs at a worksite, but can also reduce the idle time of machines, reduce fuel consumption, and increase efficiency and engagement of the machines at the worksite 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

1. A mobile machine, comprising:
a propulsion system;
one or more sensors;
a controller operably connected to the propulsion system and the one or more sensors, the controller including:
one or more processors; and
one or more non-transitory computer-readable media storing computer-executable instructions that, when executed, cause the one or more processors to perform operations comprising:
receiving, from an electronic device separate from the mobile machine, a mobilization command to perform a mobilization task, the mobilization task comprising moving the mobile machine from an initial location to a final location;
causing, using the propulsion system, the mobile machine to traverse a path on a worksite, the path including a series of waypoints, and extending from the initial location of the mobile machine to the final location;
determining, using the one or more sensors, that a present position of the mobile machine includes the final location; and
sending, based at least in part on determining that the present position includes the final location, a mobilization task completion notification to the electronic device, the mobilization task completion notification indicating that the mobilization task is complete.

2. The mobile machine of claim 1, wherein the electronic device includes a mobile device, a computer, or a server that is remote from the mobile machine and communicates with the controller wirelessly.

3. The mobile machine of claim 1, wherein causing the mobile machine to traverse the path comprises causing the propulsion system to operate under autonomous or semi-autonomous control.

4. The mobile machine of claim 1, wherein causing the mobile machine to traverse the path comprises causing the propulsion system to follow a pilot mobile machine leading the mobile machine while traversing the path.

5. The mobile machine of claim 1, wherein the operations further comprise, based at least in part on determining that the present position includes the final location, causing the mobile machine to perform a work task at the final location.

6. The mobile machine of claim 5, wherein the operations further comprise:
determining that the work task is complete; and
based at least in part on determining that the work task is complete, sending a work completion notification to the electronic device, the work completion notification indicating that the work task is completed.

7. The mobile machine of claim 1, wherein the operations further comprise:
receiving a signal from the one or more sensors, the signal including information indicating a safe operational condition of the mobile machine;
determining, based at least in part on the information, that the mobile machine is in the safe operational condition; and
based at least in part on determining that the mobile machine is in the safe operational condition, activating a mobilization mode, wherein in the mobilization mode the controller is operable to perform the mobilization task.

8. The mobile machine of claim 1, wherein the operations further comprise:
receiving a signal from the one or more sensors, the signal including information indicating that a hazard blocks the path to be traversed by the mobile machine; and
based at least in part on the information, sending a path-obstructed notification to the electronic device, the path-obstructed notification indicating that the hazard blocks the path.

9. The mobile machine of claim 1, wherein the operations further comprise:
determining, based at least in part on one or more sensor signals from the one or more sensors, a topography of a surface while traversing the path; and
modifying the path based at least in part on the topography of the surface.

10. The mobile machine of claim 1, wherein the final location is selected from a group consisting of a work area, a storing area, a staging area, a refueling area, or a recharging area.

11. One or more non-transitory computer-readable media storing computer-executable instructions that, when executed, cause one or more processors of a mobile machine to perform operations comprising:
receiving, from an electronic device separate from the mobile machine, a mobilization command to perform a mobilization task, the mobilization task comprising moving the mobile machine from an initial location to a final location at a worksite;
determining a path on the worksite, the path including a series of locations, and extending from the initial location of the mobile machine to the final location;
causing, using a propulsion system of the mobile machine, the mobile machine to traverse the path;
determining, using one or more sensors of the mobile machine, that a present position of the mobile machine is within a threshold distance of the final location; and
sending, based at least in part on determining that the present position is within the threshold distance of the final location, a mobile task completion notification to the electronic device, the mobile task completion notification indicating that the mobilization task is complete.

12. The one or more non-transitory computer-readable media of claim 11, wherein the electronic device includes a mobile device, a computer, or server that is remote from the mobile machine and communicates wirelessly.

13. The one or more non-transitory computer-readable media of claim 11, wherein the operations further comprise, based at least in part on determining that the present position is within the threshold distance of the final location, performing a work task at the final location.

14. The one or more non-transitory computer-readable media of claim 11, wherein the operations further comprise:
receiving a signal from the one or more sensors, the signal including information indicating a safe operational condition of the mobile machine;
determining, based at least in part on the information, that the mobile machine is in the safe operational condition; and
based at least in part on determining that the mobile machine is in the safe operational condition, activating a mobilization mode of the mobile machine, wherein in the mobilization mode, the mobile machine is operable to perform the mobilization task.

15. The one or more non-transitory computer-readable media of claim 11, wherein the operations further comprise:
receiving a signal from the one or more sensors, the signal including information indicating that a hazard blocks the path to be traversed by the mobile machine; and
based at least in part on the information, sending a path-obstructed notification to the electronic device, the path-obstructed notification indicating that the hazard blocks the path.

16. The one or more non-transitory computer-readable media of claim 11, wherein the determining the path on the worksite comprises following a pilot vehicle leading the mobile machine while traversing the path on the worksite.

17. A method, comprising:
receiving, by a mobile machine from an electronic device separate from the mobile machine, a mobilization command to perform a mobilization task, the mobilization task comprising moving the mobile machine from an initial location to a final location;
determining, based at least in part from factors measured by one or more sensors of the mobile machine, that the mobile machine is in a safe operational condition, the factors being related to the safe operational condition of the mobile machine; and
based at least in part to the determining that the mobile machine is in the safe operational condition, performing actions including:
causing, using a propulsion system of the mobile machine, the mobile machine to relocate from the initial location to the final location;
determining, using a positioning system of the mobile machine, that a present position of the mobile machine includes the final location; and
sending, based at least in part on determining that the present position includes the final location, a mobile task completion notification to the electronic device that indicates that the mobilization task is complete.

18. The method of claim 17, wherein the causing of the mobile machine to relocate includes:
determining a path on a worksite, the path including a series of locations, and extending from the initial location of the mobile machine to the final location; and
causing, using a propulsion system of the mobile machine, the mobile machine to traverse the path.

19. The method of claim 17, further comprising, based at least in part on determining that the present position includes the final location, causing, using a work system of the mobile machine, the mobile machine to perform a work task at the final location.

20. The method of claim 17, further comprising:
receiving a signal from the one or more sensors of the mobile machine, wherein the signal includes information indicating that a hazard blocks a path traversed by the mobile machine; and
based at least in part on the information, sending a path-obstructed notification to the electronic device, the path-obstructed notification indicating that the hazard blocks the path.
